(19) United States
(12) Patent Application Publication
(10) Pub. No.: US 2003/0022390 A1
(43) Pub. Date: Jan. 30, 2003

(54) Method and kit for making interfering substances in urine undetectable

(76) Inventor: James Matthew Stephens, Cincinnati, OH (US)

Correspondence Address: SIERRA PATENT GROUP, LTD., P O BOX 6149, STATELINE, NV, 89449, US

(21) Appl. No.: 10/163,891

(22) Filed: May 30, 2002

(51) Int. Cl. G01N 1/00

(52) U.S. Cl. 436/175; 436/904; 436/135; 436/119; 436/84; 422/61

(57) ABSTRACT

The present system comprises a method and a kit for making interfering substances undetectable in urine. The system includes a method for making interfering substances in urine undetectable comprising providing an oxidizing compound and providing a masking compound. A urine sample is collected, contacted with the oxidizing compound, and contacted with the masking compound to remove any potentially interfering substances from the urine. A kit for making interfering substances in urine undetectable is also disclosed. The kit comprises an oxidizing compound and a masking compound.

### SPECIFICATION

1. Field of the System

The present system relates to a method and kit for making urinalysis more accurate. More specifically, the present system relates to a method and kit for making interfering substances in urine undetectable.

2. Background of the System

The kidneys remove interfering substances circulating in the blood and produce urine which is excreted from the body. Consequently, diverse waste substances and other substances that are not needed by the body find their way into the urine for subsequent removal from the body.

Urinalysis is the testing of the composition and amounts of waste substances in urine, and provides a tremendously powerful tool for the medical profession. However, some of these interfering substances can hide existing medical conditions, and some others can masquerade as non-existent medical conditions, undermining the usefulness of urinalysis as a medical diagnostic tool. Some interfering substances that find their way into a urine sample are drugs and drug metabolites, given either as medicaments for conditions such as control of pain or nausea caused by chemotherapy, or voluntarily abused by the urine donor.

Recently, various immunoassays and other kinds of tests have been developed turning urinalysis into a powerful diagnostic tool. For example, quantities of drugs of abuse and other indicia of bodily disease can easily be detected by urinalysis. Some pharmaceuticals or other chemicals that might have been ingested disturb the sensitive tests making the actual state of the body difficult or impossible to determine. Among the substances that can be detected in urine, and used to diagnose medical conditions in the patient giving the sample, are insulin, para-aminohippuric acid, phenolsulfonphthalein, phosphates, arylsulfatase-A, lysosome, urine amylase, total urine estrogens, specific estrogens, progestins, aldosterone, catecholamines, 5-hydroxyindolacetic acid, cortisol, homovanillic acid, human chorionic gonadotropin, creatine, urea, uric acid, bilirubin, hemoglobin, hydroxyproline, melanin, porphyrins, total protein, acid mucopolysaccharide, copper, glucose oxidase, and urine ketone. Making potential interfering components in urine undetectable can help make the various immunoassays or assays by other techniques, such as isolation followed by gas or liquid chromatography followed by mass spectrometry, more accurate.

One compound that may be found in urine from chemotherapy to relieve the distressing symptoms of cancer chemotherapy or voluntary ingestion from abuse is tetrahydrocannabinol. A method for detecting tetrahydrocannabinol is described in U.S. Pat. No. 5,036,013, issued to Sohly et al. In this patent, various deuterated cannabinoids were synthesized to help determine the quantitative amount of tetrahydrocannabinol in a urine sample. Various methods are described therein. One method, in particular, involves spiking a urine sample with deuterated tetrahydrocannabinol and analyzing the resultant sample with gas chromatography/mass spectroscopy.

Another example of the problems created by interfering chemicals in urine is exemplified by the case of ibuprofen. Ibuprofen is a prostaglandin synthetase inhibitor that may be taken in large doses to relieve pain and inflammation characteristic of arthritis. When a patient taking these massive doses is subjected to urinalysis, it may mask other drugs of abuse, or may be mistaken for tetrahydrocannabinol. Such a misidentification of a drug of abuse can have devastating personal consequences for the tested patient. Thus, removal and masking of the compound before the test would improve the reliability of the test, and prevent possible liability to those requesting the test.

A need therefore exists to make interfering substances in urine such as tetrahydrocannabinol and ibuprofen undetectable. Thus, the interfering substances will not interfere with any needed diagnostic tests.

### SUMMARY OF THE SYSTEM

In this present system, an interfering substance such as tetrahydrocannabinol is made undetectable in a urine sample subjected to analysis by an Enzyme Multiple Immunoassay Test (EMIT) by oxidizing the interfering substance with an oxidizing composition comprising, for example, iodine pentoxide (I₂O₅) or N-bromosuccinimide and subsequently camouflaging the remaining tetrahydrocannabinol in the urine sample with 1,2-dihydroxy-4-nitrobenzene (4-nitrocatechol).

In an aspect of this system a kit for making an interfering substance such as ibuprofen or tetrahydrocannabinol undetectable in a urine sample subjected to analysis by an Enzyme Multiple Immunoassay Test (EMIT) is disclosed. The kit comprises an oxidizing agent for oxidizing the interfering substance. The kit also comprises a composition comprising an amount of 4-nitrocatechol sufficient to mask the interfering substance in a volume of urine while leaving the various physical indicia characteristic of urine unaffected.

In accordance with another aspect of the present system, a method to make urine samples free of potentially interfering substances, such as tetrahydrocannabinol, by making the interfering substances undetectable in the urine is disclosed.

The present system comprises a method including the steps of collecting a urine sample, contacting the urine sample with an oxidizing agent such as a solution comprising iodine pentoxide, and subsequent to the oxidation step contacting the urine sample with an amount of 1,2-dihydroxy-4-nitrobenzene sufficient to make the interfering substance undetectable in a volume of urine while leaving the various physical indicia characteristic of urine unaffected.

These and other features, aspects and advantages of the present system will become better understood with reference to the following description and claims.

### DETAILED DESCRIPTION OF THE SYSTEM

Those of ordinary skill in the art will realize that the following description of the present system is illustrative only and not in any way limiting. Other embodiments will readily suggest themselves to such skilled persons having the benefit of this disclosure.

Similar designations used herein are intended to designate substantially similar matter.

In general, the interfering substances to be removed from the urine are natural products or pharmaceuticals. Preferably the substances are alkaloids or other naturally occurring substances. In another embodiment, the unwanted substances are at least one of testosterone, estrogen, progesterone, anabolic steroids, ibuprofen, acetaminophen, acetosalicylic acid, benzedrine, 3,4,5 trimethoxybenzedrine, tetrahydrocannabinol, cocaine, morphine, codeine, nicotine, ethyl alcohol, and acetaldehyde.

In general, the various physical indicia characteristic of urine include pH, saccharide content, red blood cell count, nitrogen content, albumin content, protein content, immunoassayable proteins and total solids content. Immunoassayable proteins include HCG, and other proteins used to diagnose congenital diseases, cancer, and other abnormalities. It is preferred that the present system leaves the indicia required for successful testing of insulin levels, para-aminohippuric acid, phenylsulfonphthalein, phosphates, arylsulfatase-A, lysozome, urine amylase, total urine estrogens, specific estrogens, progestins, aldosterone, catecholamines, 5-hydroxyindoleacetic acid, cortisol, homovanillic acid, human chorionic gonadotropin, creatine, urea, uric acid, bilirubin, hemoglobin, hydroxyproline, melanin, porphyrins, total protein, acid mucopolysaccharide, copper, glucose oxidase and urine ketone substantially unaffected.

In the method of the disclosed system, a patient being tested provides a urine sample for subsequent urinalysis. The urine sample is collected from the patient by any of a variety of well-known conventional methods. The physician or other technician can then analyze the urine sample immediately or send it off to a specialized laboratory for subsequent analysis. Most of the urine samples taken for subsequent analysis are stored for some period of time before the analysis is undertaken.

The urine sample is first contacted with an amount of an oxidizing solution sufficient to oxidize at least 20%, preferably at least 30%, and most preferably at least 50%, of the interfering substance or substances in a volume of urine. The oxidizing solution leaves the various physical indicia characteristic of urine substantially unaffected. The means of contact can be mixing an aqueous solution of the oxidizing compound with the urine sample before testing. In an alternate embodiment, the oxidizing compound can be mixed directly with the urine prior to selection of a sample for testing. Depending on the size of the urine sample, the amount of the oxidizing agent can vary.

The oxidizing agent of the present system may vary and may include any agent known to oxidize organic components. Preferred agents include iodine pentoxide (I₂O₅), iodic acid, iodoxide, iodopentoxide, periodic acid, ortho periodic acid, hydrogen peroxide, chromium trioxide, benzoyl peroxide, sodium permanganate, sodium persulfate, N-bromosuccinimide, and potassium permanganate. Iodine pentoxide and sodium persulfate are more preferred because they do not leave trace elements in the urine sample. Trace elements are defined as traces of the oxidizing agent detectable by the EMIT testing. The oxidizing salts are preferably prepared as saturated solutions in deionized water, although more dilute solutions may be used. In another embodiment of the present system the oxidizing agent may be in a non-solution form. The aqueous solution or solid of the oxidizing agent is contacted with the urine.

After the urine sample is contacted with the oxidizing agent, as set forth above, the same urine sample is next contacted with a solution comprising a masking agent such as an amount of 1,2-dihydroxy-4-nitrobenzene sufficient to make the interfering substance in a volume of urine undetectable while leaving the various physical indicia characteristic of urine unaffected. Other preferred masking agents include dihydroxyisonicotinic acid, 4-hydroxybenzaldehyde, pyridoxine, cyanocobalamin, riboflavin, and 2-nitroresorcinol. Inorganic masking agents include dichromates, potassium permanganate and potassium ferricyanide. The masking solution leaves the various physical indicia characteristic of urine substantially unaffected. The means of contact can be mixing an aqueous solution of the masking compound with the urine sample before testing. In an alternate embodiment, the masking compound can be mixed directly with the urine prior to selection of a sample for testing.

Depending on the size of the urine sample, the amount of the masking agent can vary. However, the amount 1,2-dihydroxy-4-nitrobenzene is preferably sufficient to mask at least about 20%, preferably at least 30%, and most preferably at least 50% of the interfering substance in a volume of urine. The chemical masking agent leaves the various physical indicia characteristic of urine substantially unaffected.

In another embodiment of the system, a kit for making interfering substances undetectable in urine is disclosed. The kit comprises a solution or solid of an oxidizing agent and a solution or solid of a masking agent. The oxidizing agent of the kit may vary and may include any agent known to oxidize organic components. Preferred agents include iodine pentoxide, iodic acid, iodoxide, iodopentoxide, periodic acid, ortho periodic acid, hydrogen peroxide, chromium trioxide, benzyl peroxide, sodium permanganate, sodium persulfate, N-bromosuccinimide, and potassium permanganate. Iodine pentoxide and sodium persulfate are more preferred because they do not leave trace elements in the urine sample. The oxidizing salts are preferably prepared as saturated solutions in deionized water, although more dilute solutions may be used. In another embodiment of the present system the oxidizing agent may be a non-solution form. It is preferred to use non-colored agents, as the urine may be subjected to various colorimetric tests.

The masking agent of the kit comprises an amount of 1,2-dihydroxy-4-nitrobenzene sufficient to mask the interfering substance in a volume of urine while leaving the various physical indicia characteristic of urine unaffected. Other preferred masking agents include dihydroxyisonicotinic acid, 4-hydroxybenzaldehyde, pyridoxine, cyanocobalamin, riboflavin, and 2-nitroresorcinol. Inorganic masking agents include dichromate, potassium permanganate and potassium ferricyanide. The masking solution leaves the various physical indicia characteristic of urine substantially unaffected. The means of contact can be mixing an aqueous solution of the masking compound with the urine sample before testing. In an alternate embodiment, the masking compound can be mixed directly with the urine.

### EXAMPLES

The system can be better understood by reference to the following illustrative examples of the preferred embodiment of the system, which examples are meant to illustrate the system and not to limit the scope of the invention in any way.

### Example 1

In this example, an oxidative urine additive solution was made.

Approximately 2.0 grams of iodine pentoxide was added to enough water to make a solution with an approximate concentration of 161 mM. This solution was used in Example 3.

Similarly, a chemical oxidizing agent solution can be made with aqueous iodic acid, iodoxide, iodopentoxide, periodic acid, ortho periodic acid, aqueous hydrogen peroxide, saturated aqueous chromium trioxide, aqueous benzyl peroxide, saturated aqueous sodium permanganate, sodium persulfate, saturated aqueous N-bromosuccinimide, and saturated aqueous potassium permanganate solutions.

Also, a chemical oxidizing agent solution can be made by adding iodine pentoxide, iodic acid, iodoxide, iodopentoxide, periodic acid, ortho periodic acid, hydrogen peroxide, chromium trioxide, benzyl peroxide, sodium permanganate, sodium persulfate, N-bromosuccinimide, and potassium permanganate directly to the urine.

### Example 2

In this example, a masking urine additive solution was made.

Approximately 2.0 grams of 1,2-dihydroxy-4-nitrobenzene was added to enough water to make a solution with an approximate concentration of 81 mM. This solution was used in example 3.

Similarly, a masking solution can be made with dihydroxyisonicotinic acid, 4-hydroxybenzaldehyde, pyridoxine, cyanocobalamin, riboflavin, and 2-nitroresorcinol. Inorganic masking agents include dichromates, potassium permanganate and potassium ferricyanide.

Also, a masking solution can be made by adding dihydroxyisonicotinic acid, 4-hydroxybenzaldehyde, pyridoxine, cyanocobalamin, riboflavin, 2-nitroresorcinol, dichromates, potassium permanganate and potassium ferricyanide directly to the urine to make a solution.

### Example 3

In this example, the solutions of Examples 1 and 2 were used to make interfering substances in a urine sample undetectable.

Urine samples were collected in conventional ways. A urine composite sample taken on Apr. 1, 2002 was split into eight unequal aliquots and sent to a laboratory to be analyzed utilizing EMIT and GC/MS technology. The dates that the samples were sent to the lab varied. Sample 20401, the control, was analyzed without any further preparation. 2 mls of the oxidizing solution of Example 1 were added to samples 20402 through 20408. Subsequently, 2 mls of the solution of Example 2 were added to the samples 20402 through 20408. The samples were worked up by analysis of the absorbance of light through the sample by a spectrometer at a wavelength of 340 nm. The results are set forth below.

| | | | Before | | | | | | |
|---|---|---|---|---|---|---|---|---|---|
| | | | Addition | | | | | | |
| | | | of Oxidizing | | | | | | |
| | | Absor- | and Masking | | I₂O₅ | | 1, 2-Dihydroxy- | | |
| | Date | bance | Agents | | (Iodine Pentoxide) | | 4-nitrobenzene | | |
| Sample | Sent To | Results | | Amt. | Amt. | | Amt. | | |
| # | Lab | ng/ml | pH | (g) | (g) | mM | (g) | mM | Results |
| 20401 | Apr. 6, | 271 | 7.61 | | none | | none | | blank-no |
| | 2002 | | | | | | | | additive |
| 20402 | Apr. 3, | 0 | 5.90 | 30.00 | 2.01 | 161 mM | 2.04 | 81 mM | passed |
| | 2002 | | | | | | | | screen |
| 20403 | Apr. 7, | 24 | 6.32 | 40.00 | 2.02 | 161 mM | 2.10 | 81 mM | failed |
| | 2002 | | | | | | | | screen |
| 20404 | Apr. 3, | 0 | 6.33 | 50.00 | 2.04 | 161 mM | 2.18 | 81 mM | passed |
| | 2002 | | | | | | | | screen |
| 20405 | Apr. 3, | 0 | 6.44 | 60.01 | 2.01 | 161 mM | 2.01 | 81 mM | passed |
| | 2002 | | | | | | | | screen |
| 20406 | Apr. 4, | 0 | 6.55 | 70.01 | 2.01 | 161 mM | 2.10 | 81 mM | passed |
| | 2002 | | | | | | | | screen |
| 20407 | Apr. 11, | 0 | 6.62 | 80.02 | 2.09 | 161 mM | 1.99 | 81 mM | passed |
| | 2002 | | | | | | | | screen |
| 20408 | Apr. 11, | 0 | 6.66 | 90.02 | 2.01 | 161 mM | 2.01 | 81 mM | passed |
| | 2002 | | | | | | | screen | |

All samples with the exception of 20401 (control) and 20403 passed the screen.

While embodiments and applications of this system have been shown and described, it would be apparent to those skilled in the art that many more modifications than mentioned above are possible without departing from the inventive concepts herein. The system, therefore, is not to be restricted except in the spirit of the appended claims.

What is claimed is:

1. A method for making interfering substances in urine undetectable comprising:
providing an oxidizing compound;
providing a masking compound;
providing a urine sample and contacting said urine sample with said oxidizing compound; and
contacting said urine sample with said masking compound.

2. The method of claim 1 wherein said oxidizing compound comprises at least one of peroxides, persulfates and permanganates.

3. The method of claim 1 wherein said oxidizing compound comprises at least one of iodine pentoxide, iodic acid, iodoxide, iodopentoxide, periodic acid, ortho periodic acid, hydrogen peroxide, chromium trioxide, benzyl peroxide, sodium permanganate, sodium persulfate, N-bromosuccinimide, and potassium permanganate.

4. The method of claim 3 wherein said oxidizing compound comprises an aqueous solution.

5. The method of claim 1 wherein said masking compound comprises at least one of 1,2-dihydroxy-4-nitrobenzene, dihydroxyisonicotinic acid, 4-hydroxybenzaldehyde, pyridoxine, cyanocobalamin, riboflavin, 2-nitroresorcinol, dichromates, potassium permanganate and potassium ferricyanide.

6. The method of claim 5 wherein said masking compound comprises an aqueous solution.

7. The method of claim 1 wherein the interfering substances comprise at least one of alkaloids, testosterone, estrogen, progesterone, anabolic steroids, ibuprofen, acetaminophen, acetosalicylic acid, benzedrine, 3,4,5-trimethoxybenzedrine, tetrahydrocannabinol, cocaine, morphine, codeine, nicotine, ethyl alcohol, and acetaldehyde.

8. The method of claim 1 wherein various physical indicia characteristic of urine are unaffected by making the interfering substances undetectable in urine.

9. The method of claim 8 wherein the various physical indicia characteristic of urine comprise at least one of pH, saccharide content, red blood cell count, nitrogen content, albumin content, protein content, immunoassayable proteins and total solids content.

10. The method of claim 9 wherein the immunoassayable proteins include HCG, and other proteins used to diagnose congenital diseases, cancer, and other abnormalities.

11. The method of claim 8 wherein the physical indicia characteristic of urine comprise at least one of insulin levels, para-aminohippuric acid, phenyl sulfonphthalein, phosphates, arylsulfatase-A, lysozome, urine amylase, total urine estrogens, specific estrogens, progestins, aldosterone, catecholamines, 5-hydroxyindoleacetic acid, cortisol, homovanillic acid, human chorionic gonadotrophin, creatine, urea, uric acid, bilirubin, hemoglobin, hydroxyproline, melanin, porphyrins, total protein, acid mucopolysaccharide, copper, glucose oxidase and urine ketone remain substantially unchanged.

12. A kit for making interfering substances in urine undetectable comprising:
an oxidizing compound; and
a masking compound.

13. The method of claim 12 wherein said oxidizing compound comprises at least one of peroxides, persulfates and permanganates.

14. The kit of claim 12 wherein said oxidizing compound comprises at least one of iodine pentoxide, iodic acid, iodoxide, iodopentoxide, periodic acid, ortho periodic acid, hydrogen peroxide, chromium trioxide, benzoyl peroxide, sodium permanganate, sodium persulfate, N-bromosuccinimide, and potassium permanganate.

15. The kit of claim 14 wherein said oxidizing compound is in the form of an aqueous solution.

16. The kit of claim 12 wherein said masking compound comprises at least one of 1,2-Dihydroxy-4-nitrobenzene, dihydroxyisonicotinic acid, 4-hydroxybenzaldhyde, pyridoxine, cyanocobalamin, riboflavin, 2-nitroresorcinol, dichromate, potassium permanganate and potassium ferricyanide.

17. The kit of claim 16 wherein said masking compound is in the form of an aqueous solution.

18. The kit of claim 12 wherein the interfering substances comprise at least one of alkaloids, testosterone, estrogen, progesterone, anabolic steroids, ibuprofen, acetaminophen, acetosalicylic acid, benzedrine, 3,4,5-trimethoxybenzedrine, tetrahydrocannabinol, cocaine, morphine, codeine, nicotine, ethyl alcohol, and acetaldehyde.

19. The kit of claim 12 wherein various physical indicia characteristic of urine are unaffected by making the interfering substances undetectable in urine.

20. The kit of claim 19 wherein the various physical indicia characteristic of urine comprise at least one of pH, saccharide content, red blood cell count, nitrogen content, albumin content, protein content, immunoassayable proteins and total solids content.

21. The kit of claim 20 wherein immunoassayable proteins include HCG, and other proteins used to diagnose congenital diseases, cancer, and other abnormalities.

22. The kit of claim 20 wherein the physical indicia characteristic of urine comprise at least one of insulin levels, para-aminohippuric acid, phenyl sulfonphthalein, phosphates, arylsulfatase-A, lysozome, urine amylase, total urine estrogens, specific estrogens, progestins, aldosterone, catecholamines, 5-hydroxyindoleacetic acid, cortisol, homovanillic acid, human chorionic gonadotrophin, creatine, urea, uric acid, bilirubin, hemoglobin, hydroxyproline, melanin, porphyrins, total protein, acid mucopolysaccharide, copper, glucose oxidase and urine ketone remain substantially unchanged.
